(19) United States
(12) Patent Application Publication
(10) Pub. No.: US 2025/0030092 A1
(43) Pub. Date: Jan. 23, 2025

(54) BATTERY PACK

(71) Applicant: SAMSUNG SDI CO., LTD., Yongin-si (KR)

(72) Inventors: Soodeok MOON, Yongin-si (KR); Taeho JI, Yongin-si (KR); Beomjun WOO, Yongin-si (KR)

(21) Appl. No.: 18/744,234

(22) Filed: Jun. 14, 2024

(30) Foreign Application Priority Data
Jul. 21, 2023 (KR) 10-2023-0095515

(51) Int. Cl. H01M 10/6568; H01M 10/613; H01M 10/6554; H01M 10/6556; H01M 50/209; H01M 50/264; H01M 50/358

(52) U.S. Cl. CPC H01M 10/6568; H01M 10/613; H01M 10/6554; H01M 10/6556; H01M 50/209; H01M 50/264; H01M 50/358

(57) ABSTRACT

A battery pack includes a base plate in which two or more battery cells are in contact with a first surface of the base plate and a base flow path through which a refrigerant that cools the battery cell circulates is in the base plate; and a frame portion in which a two or more frames are coupled to each other at an upper side of the first surface of the base plate to form an accommodation space for accommodating the battery cells and a side surface flow path through which the refrigerant flows in and out by being connected to the base flow path is formed therein.

### CROSS-REFERENCE TO RELATED APPLICATION

The present application claims priority to and the benefit of Korean Patent Application No. 10-2023-0095515, filed on Jul. 21, 2023, in the Korean Intellectual Property Office, the entire disclosure of which is incorporated herein by reference.

### BACKGROUND

### 1. Field of the Invention

The present disclosure relates to a battery pack.

### 2. Description of the Related Art

In general, a secondary battery (or a rechargeable battery) is widely used in a mobile device, an auxiliary electric power device, or the like.

In addition, the secondary battery is also attracting attention as a main power source for an electric vehicle, a hybrid electric vehicle, a plug-in hybrid electric vehicle, or the like, which have been proposed as an alternative to solve various problems such as air pollution of a conventional gasoline or diesel vehicle.

In the electric vehicle or the like, a battery pack is formed by stacking a plurality of battery cells and then electrically connecting the battery cells in series and/or in parallel to achieve a high-output and large-capacity battery.

The plurality of battery cells are stacked in the battery pack, and terminals exposed at both ends of each battery cell are electrically connected to provide a high voltage.

However, the battery pack that generates the high voltage requires more effective cooling of the battery cell to improve driving stability during continued use of the battery pack.

The above-described information disclosed in the technology that serves as the background of the present disclosure is only for improving understanding of the background of the present disclosure and thus may include information that does not constitute the related art.

### SUMMARY

Embodiments of the present disclosure relate to a battery pack capable of cooling three surfaces of a plurality of battery cells accommodated inside a frame portion to provide more effective cooling of the battery cells.

In one embodiment, the battery pack includes battery cells; a base plate including a first surface and a base flow path, wherein the battery cells are in contact with the first surface and the base flow path is configured to circulate a refrigerant to cool the battery cells; and a frame portion including frames coupled to each other at an upper side of the first surface of the base plate. The frame portion forms an accommodation space for accommodating the battery cells and a side surface flow path connected to the base flow path through which the refrigerant is configured to flow.

The base plate may include a cooling plate including the first surface and the base flow path; a flow path connection portion coupled to one end of the cooling plate and connecting the side surface flow path of the frame portion and the base flow path; and a refrigerant guiding portion coupled to another end of the cooling plate. The refrigerant guiding portion is configured to guide a flow of the refrigerant introduced into the base flow path in a discharge direction through the flow path connection portion.

The base flow path may include an inflow flow path through which the refrigerant introduced through the flow path connection portion moves in a first direction inside the cooling plate and a discharge flow path in which a flow direction of the refrigerant introduced through the inflow flow path is reversed at a position of the refrigerant guiding portion to move in a second direction opposite to the first direction, the inflow flow path extends along the first direction inside one side of the cooling plate to introduce the refrigerant and is connected to the discharge flow path at the position of the refrigerant guiding portion, and the discharge flow path is connected to the inflow flow path inside the cooling plate.

The battery pack may include a first coupling groove at the one end of the cooling plate coupled to the flow path connection portion. The first coupling groove opens a portion of each of the inflow flow path and the discharge flow path.

The flow path connection portion may include a first connection portion coupled to the one end of the cooling plate to connect the inflow flow path to the side surface flow path of the frame portion; and a second connection portion coupled to the one end of the cooling plate to connect the discharge flow path to the side surface flow path of the frame portion.

The first connection portion may include a first bending plate including one side covering the first coupling groove and another side extending in a thickness direction of the cooling plate, and a first pipe line protruding from an upper side of the first bending plate and extending into the frame portion and connecting the inflow flow path and the side surface flow path. The second connection portion may include a second bending plate including one side covering the first coupling groove and another side extending in the thickness direction of the cooling plate, and a second pipe line protruding from an upper side of the second bending plate and extending into the frame portion and connecting the inflow flow path and the side surface flow path.

The battery pack may include a second coupling groove at another end of the cooling plate. The second coupling groove is coupled to the refrigerant guiding portion and opens a portion of each of the inflow flow path and the discharge flow path.

The refrigerant guiding portion may include a second bending plate including one side covering the second coupling groove and another side extending in a thickness direction of the cooling plate.

The frame portion may include a composite frame coupled to one edge of the base plate in which the first side surface flow path is inside the composite frame and the first side surface flow path is connected to the first connection portion and the second connection portion to supply the refrigerant; an end frame coupled to the another edge of the base plate; a first side frame having each end connected to one end of each of the composite frame and the end frame; and a second side frame having each end connected to another end of each of the composite frame and the end frame.

The battery pack may include a gas discharge portion in the composite frame configured to discharge a gas generated from one of the battery cells in which the gas discharge portion includes a gas inflow portion on a first side surface of the composite frame and through which the gas generated from the one of the battery cells is introduced and a gas venting portion at the composite frame through which the gas introduced into the gas inflow portion is discharged to the outside.

An inside of the composite frame may be divided into a first region and a second region in which the first side surface flow path is at the first region, and in which the gas venting portion is at the second region.

The gas venting portion may include a venting unit protruding from a second side surface facing the first side surface of the composite frame and a guiding portion protruding from an inner wall surface of the second region inside the composite frame. The venting unit is configured to discharge the gas and the guiding portion is configured to guide the gas toward the venting unit.

The frame portion may include a side surface cooling frame in contact with side surfaces of the plurality of battery cells.

One side of the side surface cooling frame may be connected to the first side surface flow path of the composite frame in which another side of the side surface cooling frame extends in a direction toward the end frame, and in which a second side surface flow path through which the refrigerant flows is inside the side surface cooling frame.

The first side surface flow path may include an upper flow path connected to the first pipe line and a lower flow path connected to the second pipe line, and the second side surface flow path may include a side surface upper flow path extending in a length direction inside the side surface cooling frame and connected to the upper flow path of the composite frame and a side surface lower flow path extending in the length direction inside the side surface cooling frame and at a lower portion of the side surface upper flow path to be connected to the lower flow path of the composite frame.

The battery pack may include a side surface refrigerant guiding portion at another side of the side surface cooling frame in which the side surface refrigerant guiding portion is configured to change a flow direction of the refrigerant flowing through the side surface upper flow path to a direction of the side surface lower flow path.

The inflow flow path may include a first inflow flow path extending along the first direction at one side of the cooling plate to introduce the refrigerant and connected to the discharge flow path and a second inflow flow path extending along the first direction at another side of the cooling plate to introduce the refrigerant and connected to the discharge flow path, and in which the discharge flow path includes a first discharge flow path extending along the first direction between the first inflow flow path and the second inflow flow path inside the cooling plate and connected to the first inflow flow path to discharge the refrigerant and a second discharge flow path extending along the first direction between the first inflow flow path and the second inflow flow path inside the cooling plate and connected to the second inflow flow path to discharge the refrigerant.

The flow path connection portion may include a first connection portion coupled to the one end of the cooling plate to connect the first inflow flow path and the second inflow flow path to the side surface flow path of the frame portion; and a second connection portion coupled to the one end of the cooling plate to connect the first discharge flow path and the second discharge flow path to the side surface flow path of the frame portion.

The inflow flow path may include a first inflow flow path extending along the first direction inside one edge portion of the cooling plate so that the refrigerant is introduced and connected to the discharge flow path, a second inflow flow path extending along the first direction inside an edge portion of another side of the cooling plate so that the refrigerant is introduced and connected to the discharge flow path, and a common inflow flow path comprising two flow paths extending along the first direction inside the cooling plate between the first inflow flow path and the second inflow flow path and connected to the discharge flow path. The discharge flow path may include a first common discharge flow path extending along the first direction inside the cooling plate between the first inflow flow path and the common inflow flow path and connected to each of the first inflow flow path and the common inflow flow path to discharge the refrigerant and a second common discharge flow path extending along the first direction inside the cooling plate between the second inflow flow path and the common inflow flow path and connected to each of the second inflow flow path and the common inflow flow path to discharge the refrigerant.

The flow path connection portion may include a first connection portion coupled to the one end of the cooling plate to connect the first inflow flow path, the second inflow flow path, and the common inflow flow path to the side surface flow path of the frame portion; and a second connection portion coupled to the one end of the cooling plate to connect the first common discharge flow path and the second common discharge flow path to the side surface flow path of the frame portion.

According to the embodiments of the present disclosure, three surfaces of a lower portion and a side surface of a battery cell may be effectively cooled in a state in which a plurality of battery cells including the battery cell are accommodated inside a frame portion. Cooling the battery cells is configured to extend usage lifespan of the battery pack and improve the durability of the battery pack.

### BRIEF DESCRIPTION OF THE DRAWINGS

FIG. 1 is a perspective view schematically showing a battery pack according to a first embodiment of the present disclosure.

FIG. 2 is an exploded perspective view schematically showing the battery pack of FIG. 1.

FIG. 3 is a main portion exploded perspective view schematically showing a base plate according to the first embodiment of the present disclosure.

FIG. 4 is a plan view schematically showing the base plate of FIG. 3.

FIG. 5 is a perspective view schematically showing a flow path connection portion according to the first embodiment of the present disclosure.

FIG. 6 is a perspective view schematically showing a refrigerant guiding portion according to the first embodiment of the present disclosure.

FIG. 7 is a cross-sectional view schematically showing a composite frame according to the first embodiment of the present disclosure.

FIG. 8 is a cross-sectional view cut along a line A-A installed at the composite frame of FIG. 1.

FIG. 9 is a cross-sectional view cut along a line B-B of FIG. 1.

FIG. 10 is a perspective view schematically showing a side surface cooling frame according to the first embodiment of the present disclosure.

FIG. 11 is a main portion exploded perspective view schematically showing in a state in which a first plug, a second plug, and a side surface refrigerant guiding portion of the side surface cooling frame of FIG. 10 are separated.

FIG. 12 is a cross-sectional view schematically showing the side surface cooling frame of FIG. 10.

FIG. 13 is a perspective view schematically showing a battery pack according to a second embodiment of the present disclosure.

FIG. 14 is an exploded perspective view schematically showing the battery pack of FIG. 13.

FIG. 15 is a plan view schematically showing a base plate of FIG. 13.

FIG. 16 is a main portion cross-sectional view that is cut along a line C-C of FIG. 13 and schematically shows a state in which a composite frame and the base plate are connected by a flow path connection portion.

FIG. 17 is a main portion cross-sectional view cut along a line D-D of FIG. 13.

FIG. 18 is a perspective view schematically showing a battery pack according to a third embodiment of the present disclosure.

FIG. 19 is an exploded perspective view schematically showing the battery pack of FIG. 18.

FIG. 20 is a plan view schematically showing a base plate of FIG. 18.

FIG. 21 is a main portion cross-sectional view that is cut along a line F-F of FIG. 18 and schematically shows a state in which a composite frame and the base plate are connected by a flow path connection portion.

FIG. 22 is a main portion cross-sectional view cut along a line F-F of FIG. 18.

### DETAILED DESCRIPTION OF THE EMBODIMENTS

The present disclosure will be described more fully hereinafter with reference to the accompanying drawings, in which embodiments of the disclosure are shown. As those skilled in the art would realize, the described embodiments may be modified in various different ways, all without departing from the spirit or scope of the present disclosure. The drawings and description are to be regarded as illustrative in nature and not restrictive. Like reference numerals designate like elements throughout the specification.

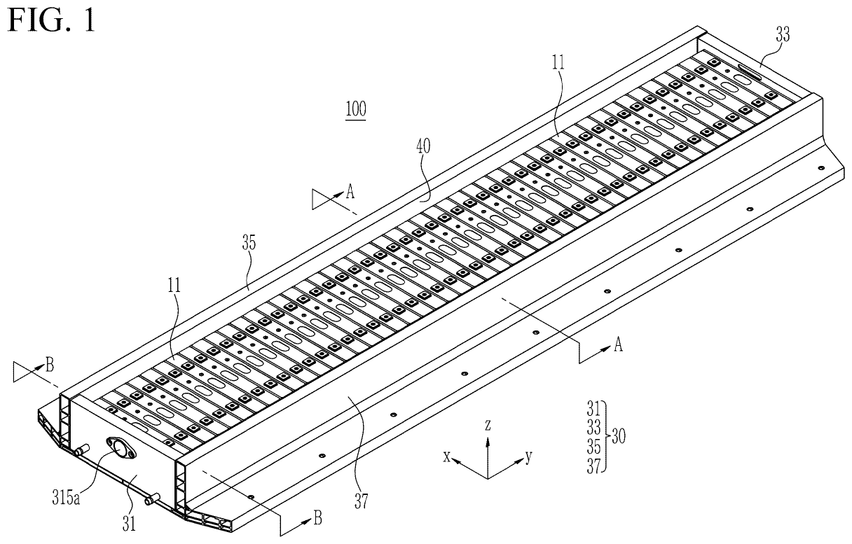

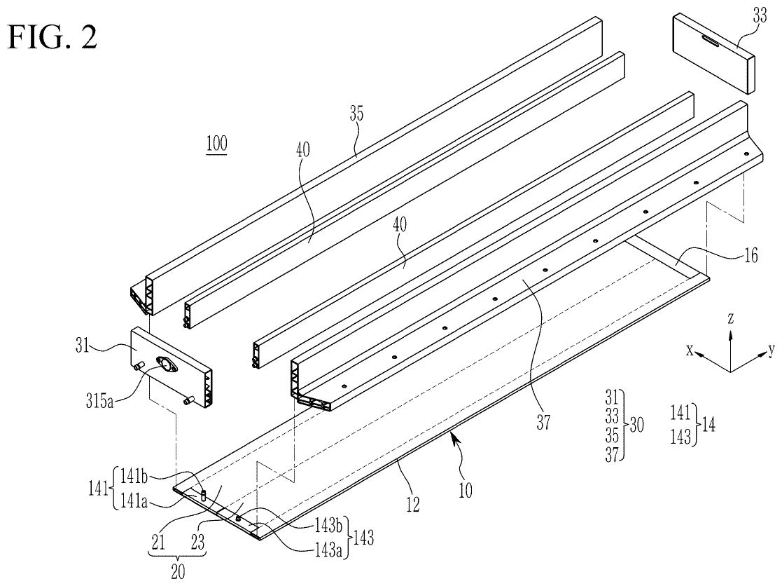

FIG. 1 is a perspective view schematically showing a battery pack according to a first embodiment of the present disclosure, and FIG. 2 is an exploded perspective view schematically showing the battery pack of FIG. 1.

As shown in FIG. 1 and FIG. 2, the battery pack 100 according to the first embodiment of the present disclosure may include a base plate 10 in which a plurality of battery cells 11 are in contact with a first surface and a base flow path 20 through which a refrigerant that cools the battery cells 11 circulates. The battery pack 100 also includes a frame portion 30 in which a plurality of frames are coupled to each other at an upper side of the first surface of the base plate 10 to form an accommodation space for accommodating the battery cells 11. The frame portion 30 includes a side surface flow path through which the refrigerant flows in and out by being connected to the base flow path 20.

The plurality of battery cells 11 may include a secondary battery that is configured to repeatedly performs charging and discharging operations.

The plurality of battery cells 11 may be accommodated inside frame portions 30 in a state in which a lower surface of each of the battery cells 11 is in contact with the first surface that is an upper surface of the base plate 10.

The plurality of battery cells 11 may be cooled to an appropriate temperature by the refrigerant flowing along the base flow path 20 formed inside the base plate 10 while the lower surface of each of the battery cells 11 is supported by the base plate 10.

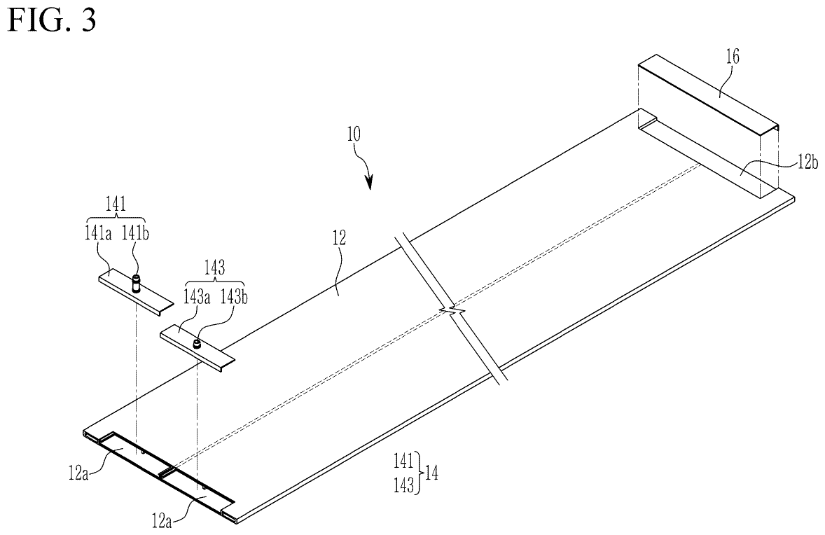

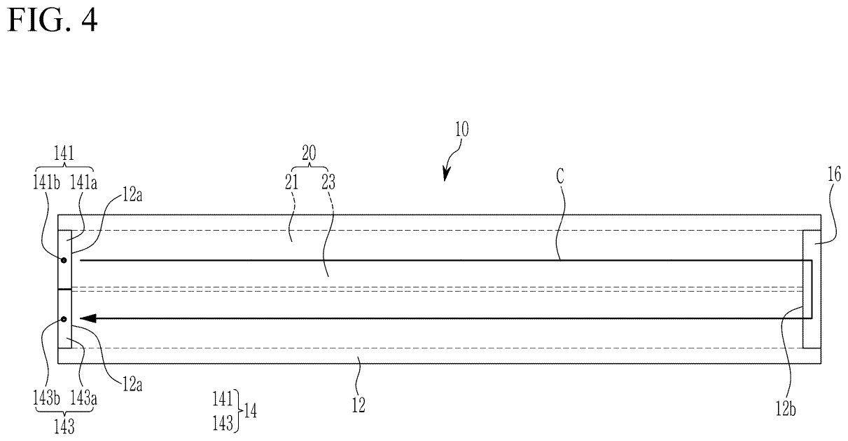

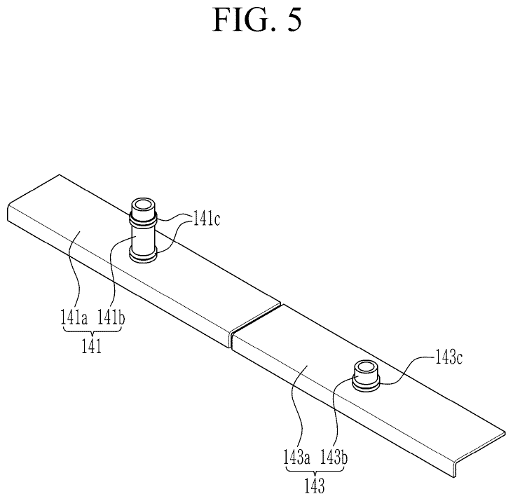

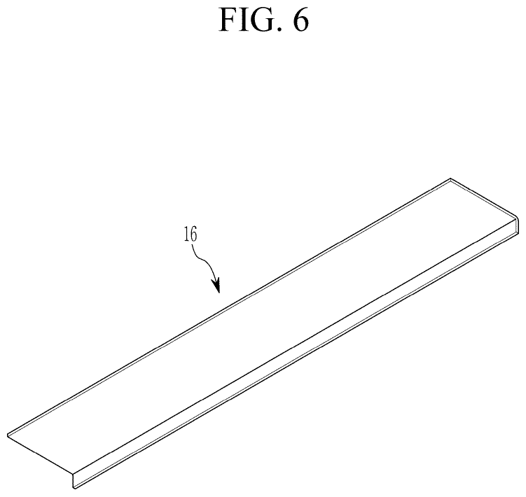

FIG. 3 is an exploded perspective view schematically showing the base plate 10 according to the first embodiment of the present disclosure, FIG. 4 is a plan view schematically showing the base plate of FIG. 3, FIG. 5 is a perspective view schematically showing a flow path connection portion according to the first embodiment of the present disclosure, and FIG. 6 is a perspective view schematically showing a refrigerant guiding portion according to the first embodiment of the present disclosure.

Referring to FIGS. 3 to 6, the base plate 10 may include a cooling plate 12 in which the plurality of battery cells 11 are in contact with a first surface and the base flow path 20 is formed. The flow path connection portion 14 is coupled to one end of the cooling plate 12 and connecting to a first side surface flow path 311 of the frame portion 30 and the base flow path 20. A refrigerant guiding portion 16 is coupled to the other end of the cooling plate 12 and is configured to guide a flow of the refrigerant introduced into the base flow path 20 in a discharge direction through the flow path connection portion 14.

The cooling plate 12 may have a rectangular planar shape with a length in a first direction (a y-axis) to support the plurality of battery cells 11 arranged in the first direction on the first surface of the cooling plate 12. A shape of the cooling plate 12 is not necessarily limited to the rectangular planar shape, and may have any other suitable shape depending on the number and arrangement of the battery cells 11.

The base flow path 20 for cooling the battery cell 11 may be inside the cooling plate 12.

The base flow path 20 may include an inflow flow path 21 through which the refrigerant flows inward (or is introduced) through the flow path connection portion 14 and flows in the first direction (the Y-axis direction) inside the cooling plate 12, and a discharge flow path 23 through which the refrigerant is discharged by switching a flow direction of the refrigerant at a position of the refrigerant guiding portion 16.

The inflow flow path 21 may be inside the cooling plate 12 and have a length direction along one edge of the cooling plate 12.

The inflow flow path 21 may be a single flow path inside the cooling plate 12 and may be configured such that the refrigerant C flowing in through the flow path connection portion 14 (that will be described later) flows along the first direction.

In one or more embodiments, the refrigerant C of FIG. 4 may be supplied to the inside of the inflow flow path 21 through the flow path connection portion 14 at one end of the cooling plate 12. A configuration of the flow path connection portion 14 according to one embodiment will be described in more detail below.

The inflow flow path 21 may be connected to the discharge flow path 23 inside the cooling plate 12 to enable circulation of the refrigerant C.

The discharge flow path 23 may be connected to the inflow flow path 21 at the other end of the cooling plate 12, and may be connected to the inflow flow path 21 at a position of the refrigerant guiding portion 16 at the other end of the cooling plate 12.

In one or more embodiments, the refrigerant C may be introduced through the inflow flow path 21 and the flow of the refrigerant C may change direction at a position of the refrigerant guiding portion 16 such that the refrigerant C is discharged through the discharge flow path 23.

The flow path connection portion 14 may be coupled to one end of the cooling plate 12.

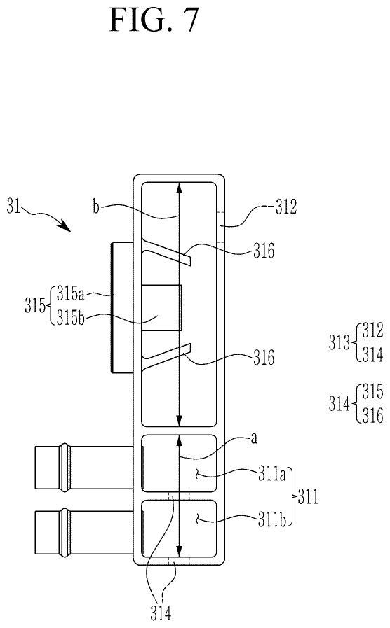

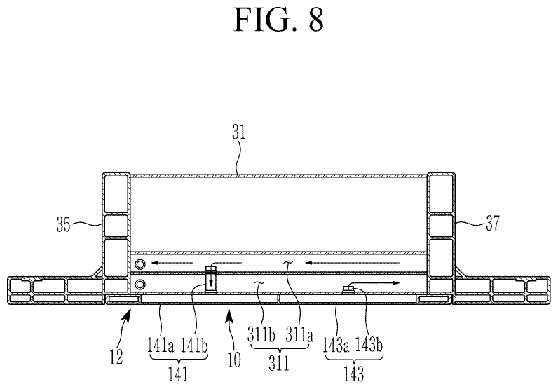

The flow path connection portion 14 may be coupled to the one end of the cooling plate 12 to connect the inflow flow path 21 and the discharge flow path 23 of the cooling plate 12 to the first side surface flow path 311 (see FIGS. 7-8) of the frame portion 30.

In one or more embodiments, the flow path connection portion 14 may include a first connection portion 141 coupled to the one end of the cooling plate 12 to connect the inflow flow path 21 to the first side surface flow path 311 of the frame portion 30, and a second connection portion 143 coupled to the same end of the cooling plate 12 to connect the discharge flow path 23 to the side surface flow path 311 of the frame portion 30.

A first coupling groove 12a (see FIG. 3) may be at the one end of the cooling plate 12 to connect the first connection portion 141 and the second connection portion 143.

The first coupling groove 12a may be configured such that a portion of each end of the inflow flow path 21 and the discharge flow path 23 is open facing upward (e.g., in the Z-axis direction).

The first connection portion 141 may include a first bending plate 141a that covers the first coupling groove 12a, and a first pipe line 141b that protrudes upward from the first bending plate 141a to be connected to the first side surface flow path 311 of a composite frame 31.

One side of the first bending plate 141a may cover the first coupling groove 12a, and the other side of the first bending plate 141a may be bent to extend in a thickness direction (downward in the Z-axis direction) of the cooling plate 12. The first bending plate 141a may be coupled to the first coupling groove 12a by a fastening member, an adhesive, or the like.

The first pipe line 141b may protrude upward from an upper portion of the first bending plate 141a.

The first pipe line 141b may protrude upward from the upper portion of the first bending plate 141a to be connected to the first side surface flow path 311 in the composite frame 31 of the frame portion 30. The first side surface flow path 311 may include an upper flow path 311a and a lower flow path 311b, and the first pipe line 141b may be connected to the upper flow path 311a. This will be described in more detail below with respect to the description of the frame portion 30.

In one or more embodiments, the first pipe line 141b may be connected to the first side surface flow path 311 in the composite frame 31 of the frame portion 30 (which will be described later) such that the refrigerant C flowing along the first side surface flow path 311 is stably connected to the inflow flow path 21 inside the cooling plate 12.

A first sealing member 141c may be at an outer surface of the first pipe line 141b.

The first sealing member 141c may be on the outside of the first pipe line 141b to prevent (or at least mitigate) the refrigerant C from leaking to the outside.

The first sealing member 141c may include a plurality of first sealing members on the outer surface of the first pipe line 141b.

In one or more embodiments, the first sealing member 141c may include a pair of first sealing members at positions spaced apart from each other (e.g., at upper and lower positions of the first pipe line 141b). In an embodiment in which the first sealing member 141c includes a pair of first sealing members at upper and lower positions of the first pipe line 141b and the first pipe line 141b is longer than a length of the second pipe line 143b, the refrigerant C may be more effectively prevented from leaking to the outside from.

In one or more embodiments, the second connection portion 143 may be coupled at one end of the cooling plate 12 (e.g., the same end of the cooling plate 12 as the first connection portion) to connect the discharge flow path 23 to the first side surface flow path 311 of the frame portion 30.

The second connection portion 143 may include a second bending plate 143a that covers the first coupling groove 12a at the discharge flow path 23, and a second pipe line 143b that protrudes upward from the second bending plate 143a to be connected to the first side surface flow path 311.

One side of the second bending plate 143a may cover the first coupling groove 12a formed at the discharge flow path 23, and the other side of the second bending plate 143a may be bent to extend in a thickness direction (downward in the Z-axis direction) of the cooling plate 12. The second bending plate 143a may be coupled to the first coupling groove 12a by a fastening member, an adhesive, or the like.

The second pipe line 143b may protrude upward from an upper portion of the second bending plate 143a to be connected to the first side surface flow path 311 in the composite frame 31 of the frame portion 30. The first side surface flow path 311 may include the upper flow path 311a and the lower flow path 311b, and the second pipe line 143b may be connected to the lower flow path 311b. This will be described in more detail below with respect to the description of the frame portion 30.

The second sealing member 143c may be a single piece on an outer surface of the second pipe line 143b. In an embodiment in which the first pipe line 141b has a length shorter than a length of the second pipe line 143b, the second sealing member 143c may be a single piece on the outer surface of the second pipe line 143b to prevent (or at least mitigate) leakage of the refrigerant C.

In one or more embodiments, the refrigerant may be circularly supplied (closed loop) from the frame portion 30 toward the cooling plate 12 by the flow path connection portion 14 including the first connection portion 141 and the second connection portion 143.

In one or more embodiments, the refrigerant C may be introduced through the inlet flow path 21 to be circularly discharged through the discharge flow path 23, and the refrigerant guiding portion 16 may be located at a connected portion (e.g., a junction) of the inflow flow path 21 and the discharge flow path 23 for the circulating supply.

In one or more embodiments, a second coupling groove 12b (see FIG. 3) coupled to the refrigerant guiding portion 16 by opening or exposing a portion of the inflow flow path 21 and a portion of the discharge flow path 23 may be located at the other end (i.e., the opposite end) of the cooling plate 12.

One side of the refrigerant guiding portion 16 may cover the second coupling groove 12b, and the other side of the refrigerant guiding portion 16 may be bent to be used (or applied) as a third bending plate extending in a thickness direction (the Z-axis direction) of the cooling plate 12.

The second bending plate 143a may be coupled to the second coupling groove 12b at the end of the cooling plate 12 opposite to the first coupling groove 12a, and may be coupled to the second coupling groove 12b at each of the inflow flow path 21 and the discharge flow path 23.

In one or more embodiments, as the refrigerant moves through the inflow flow path 21, the refrigerant may hit the second bending plate 143a so that a flow direction of the refrigerant is changed. Thus, the refrigerant may stably move in a direction of the discharge flow path 23.

In one or more embodiments, the frame portion 30 may be coupled to an upper portion of the base plate 10 to accommodate the plurality of battery cells 11.

In one or more embodiments, the frame portion 30 may include the composite frame 31, an end frame 33, and a first side frame 35 and a second side frame 37 connecting the composite frame 31 and the end frame 33, respectively. Each of the composite frame 31, the end frame 33, the first side frame 35, and the second side frame 37 are coupled to the upper portion of the base plate 10.

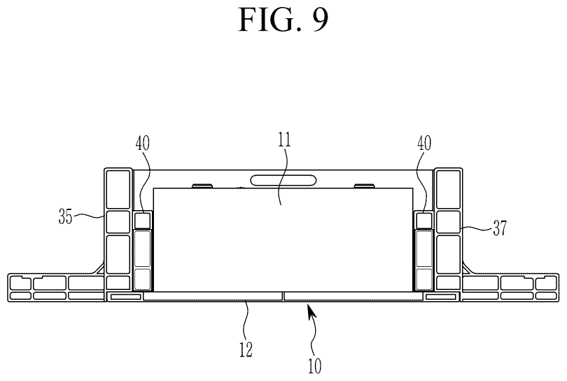

FIG. 7 is a cross-sectional view schematically showing the composite frame 31 according to the first embodiment of the present disclosure, FIG. 8 is a cross-sectional view cut along a line A-A installed at the composite frame 31 of FIG. 1, and FIG. 9 is a cross-sectional view cut along a line B-B of FIG. 1.

As shown in FIGS. 7 to 9, the composite frame 31 may be coupled to one edge of the base plate 10, and the first side surface flow path 311 may be inside the composite frame 31 to be connected to the first connection portion 141 and the second connection portion 143 so that the first side surface flow path 311 is configured to supply the refrigerant.

The first side surface flow path 311 may be inside the composite frame 31 to supply the refrigerant to the first connection portion 141 and the second connection portion 143.

The first side surface flow path 311 may include the upper flow path 311a to which the first pipe line 141b is connected, and the lower flow path 311b to which the second pipe line 143b is connected.

The upper flow path 311a may be a portion configured to introduce the refrigerant (or a coolant), and may be formed by dividing (or partitioning) a portion of the inside of the composite frame 31. The upper flow path 311a may be connected to the first pipe line 141b to enable supply of the refrigerant.

The lower flow path 311b may be below the upper flow path 311a inside the composite frame 31, and may be configured to provide a space through which the refrigerant flowing along the discharge flow path 23 may be discharged.

In one or more embodiments, a gas discharge portion 313 for discharging a gas generated from the battery cells 11 may be inside the composite frame 31.

The gas discharge portion 313 may include a gas inflow portion 312 on a first side surface of the composite frame 31 and through which the gas generated from the battery cell(s) 11 is introduced, and a gas venting portion 314 at the composite frame 31 and through which a gas introduced through the gas inflow portion 312 is discharged to the outside.

The gas inflow portion 312 may be at the first side surface where one of the battery cells 11 is in surface contact at an upper side of the first side surface flow path 311 in the composite frame 31, and the gas inflow portion 312 may be a gas inflow hole through which a portion of the first side surface is penetrated.

The inside of the composite frame 31 may be divided into a first region “a” and a second region “b”, as shown in FIG. 7. The first side surface flow path 311 may be at the first region “a”, and the gas venting portion 314 may be at the second region “b”.

The gas venting portion 314 may include a venting unit (or a venting portion) 315 protruding from a second side surface facing the first side surface of the composite frame 31 to discharge the gas, and a guiding portion (or a guide portion) 316 protruding from an inner wall surface of the second region b inside the composite frame 31 to guide the gas toward the venting unit 315. The guiding portion 316 may be around (e.g., surrounding) the venting unit 315.

The venting unit 315 may be detachably coupled to the second side surface of the composite frame 31, and may be configured such that the gas discharged from the battery cell(s) 11 and introduced into the gas inflow portion 312 may be easily discharged to the outside.

The venting unit 315 may include a venting body 315a coupled to the second side surface of the composite frame 31, and a venting protruding portion 315b protruding from a side surface of the venting body 315a into the second region b and having a venting flow path formed therein.

The gas introduced through the gas inflow portion 312 may be guided by the guiding portion 316 to pass through the venting protruding portion 315b such that the gas is discharged to the outside.

The guiding portion 316 may protrude inside the composite frame 31 at a position where the venting unit 315 is located.

The guiding portion 316 may obliquely protrude into the second region b from an inner wall surface of the composite frame 31 at a location where the venting unit 315 is located. The guiding portion 316 is configured such that the gas introduced through the gas inflow portion 312 easily moves to the venting unit 315.

The guiding portion 316 may protrude from the inner wall surface of the composite frame 31 with the venting protruding portion 315b inside the guiding portion 316. The guiding portion 316 may be or include a cone-shaped guide protruding portion with an open end portion. The guiding portion 316 may taper in a direction extending away from the inner wall surface of the composite frame 31 on which the venting unit 315 is located.

In one or more embodiments, the end frame 33 may be coupled to the other edge of the base plate 10.

The first side frame 35 may be configured such that both ends of the first side frame 35 are connected to one end of each of the composite frame 31 and the end frame 33.

Both ends of the second side frame 37 may be connected to the other end of each of the composite frame 31 and the end frame 33.

In one or more embodiments, a side surface cooling frame 40 that is in contact with a side surface of the plurality of battery cells 11 may be provided along at least a portion of the frame portion 30.

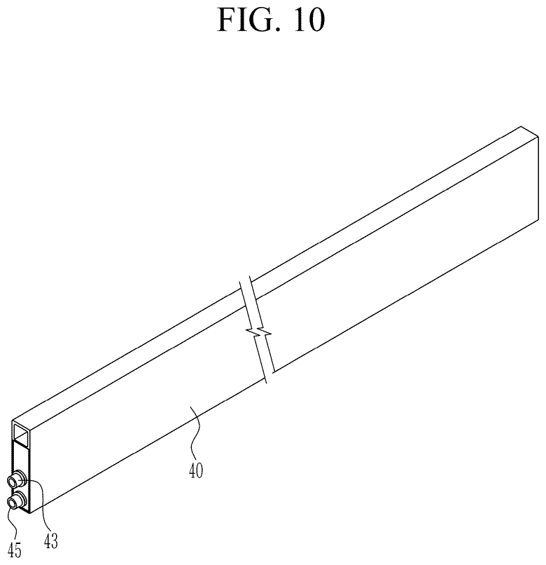

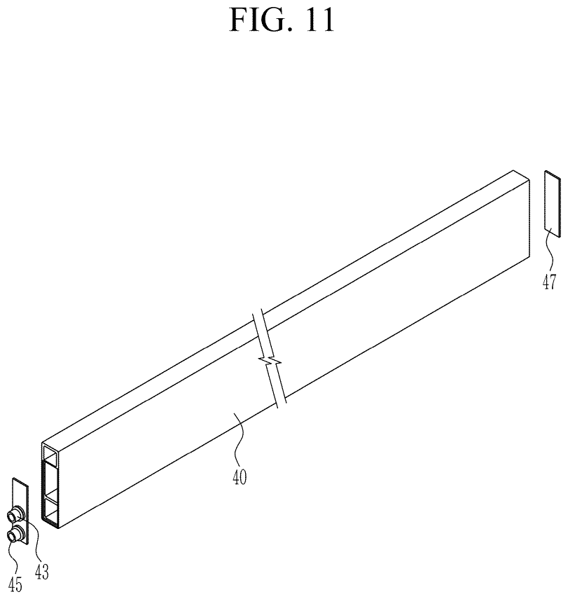

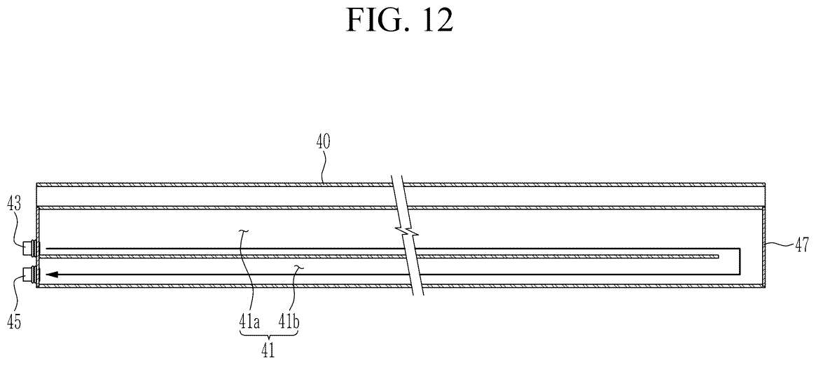

FIG. 10 is a perspective view schematically showing the side surface cooling frame 40 according to the first embodiment of the present disclosure, FIG. 11 is an exploded perspective view schematically showing in a state in which a first plug, a second plug, and a side surface refrigerant guiding portion of the side surface cooling frame 40 of FIG. 10 are separated, and FIG. 12 is a cross-sectional view schematically showing the side surface cooling frame 40 of FIG. 10.

As shown in FIGS. 1 to 12, the assembly may include a plurality of side surface cooling frames 40 spaced apart from each other at the frame portion 30, and the side surface cooling frames 40 may be configured to cool the battery cells 11 by contacting the side surface of the plurality of battery cells 11 accommodated inside the frame portion 30.

One side of the side surface cooling frame 40 may be connected to the first side surface flow path 311 of the composite frame 31, the other side of the side surface cooling frame 40 may extend in a direction toward the end frame 33, and the second side surface flow path 41 through which the refrigerant flows may be inside the side surface cooling frame 40.

The second side surface flow path 41 may include a side surface upper flow path 41a extending in a lengthwise direction (the Y-axis direction) inside the side surface cooling frame 40 and connected to the upper flow path 311a of the composite frame 31, and a side surface lower flow path 41b extending in the lengthwise direction (the Y-axis direction) inside the side surface cooling frame 40 and at a lower portion of the side surface upper flow path 41a to be connected to the lower flow path 311b of the composite frame 31.

In one or more embodiments, the refrigerant may be supplied from the frame portion 30 to the side surface upper flow path 41a to circulate in the side surface lower flow path 41b.

The first plug 43 connecting the side surface upper flow path 41a to the upper flow path 311a of the composite frame 31 and the second plug 45 connecting the side surface lower flow path 41b to the lower flow path 311b of the composite frame 31 may be installed at one side of the side surface cooling frame 40.

The first plug 43 may pass through a side surface of the composite frame 31 to be connected to the upper flow path 311a. In one or more embodiments, the refrigerant flowing along the upper flow path 311a of the composite frame 31 may be introduced into the side surface upper flow path 41a of the side surface cooling frame 40 through the first plug 43.

The second plug 45 may pass through the side surface of the composite frame 31 to be connected to the lower flow path 311b. In one or more embodiments, the refrigerant flowing through the side surface upper flow path 41a may be introduced into the lower flow path 311b through the second plug 45.

In one or more embodiments, the side surface refrigerant guiding portion 47 may be at the other side of the side surface cooling frame 40.

The side surface refrigerant guiding portion 47 may be coupled to the other side of the side surface cooling frame 40 as a plate shape, and may be configured to contact each of the side surface upper flow path 41a and the side surface lower flow path 41b.

In one or more embodiments, the refrigerant may be introduced from the side surface upper flow path 41a to hit the side surface refrigerant guiding portion 47 such that a flow direction of the refrigerant is changed. In this manner, the refrigerant may circulate to the side surface lower flow path 41b.

As described above, the battery pack 100 of the present embodiment may effectively cool three surfaces of a lower portion and a side surface of the battery cell 11 in a configuration in which the plurality of battery cells 11 including the battery cell are accommodated inside the frame portion 30. Cooling the battery cells 11 is configured to extend usage lifespan of the battery pack and improve durability of the battery pack.

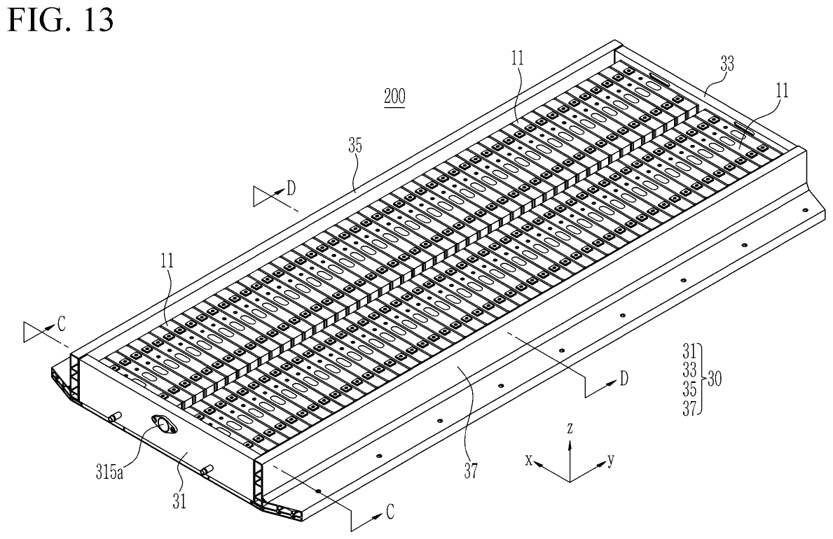

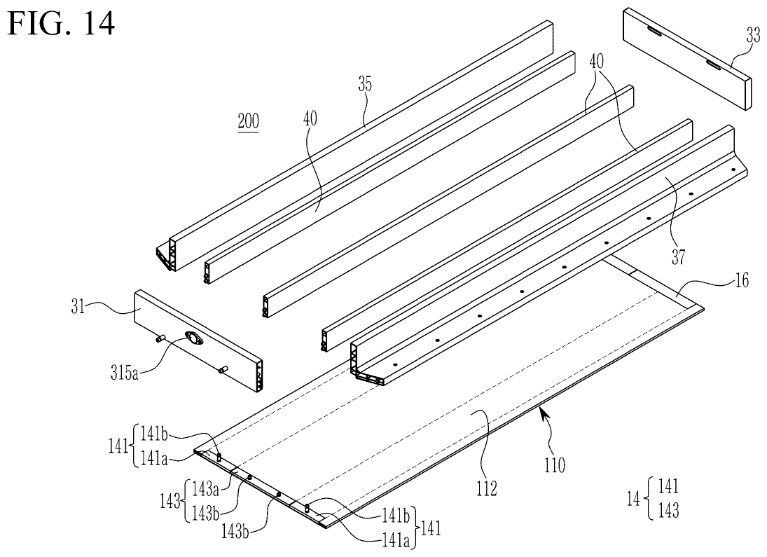

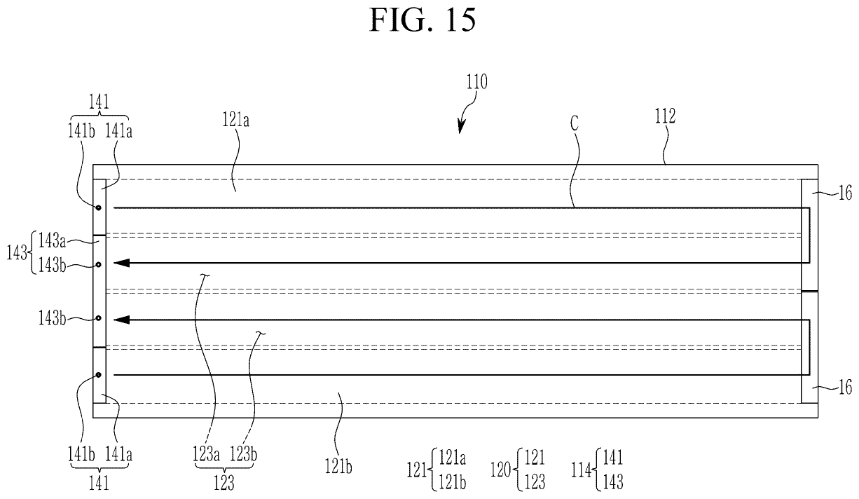

FIG. 13 is a perspective view schematically showing a battery pack according to a second embodiment of the present disclosure, FIG. 14 is an exploded perspective view schematically showing the battery pack of FIG. 13, and FIG. 15 is a plan view schematically showing a base plate of FIG. 13. The same reference numeral as that in FIGS. 1 to 12 denotes the same or similar member having the same or similar function. Hereinafter, a detailed description of the same reference numerals is omitted.

As shown in FIGS. 13 to 15, the base plate 110 of the battery pack 200 according to the second embodiment of the present disclosure may include a cooling plate 112 in which the plurality of battery cells 11 are in contact with a first surface of the cooling plate 112. A base flow path 120 is formed in the cooling plate 112. A flow path connection portion 114 is coupled to one end of the cooling plate 112 and connects the first side surface flow path 311 of the frame portion 30 and the base flow path 120. The refrigerant guiding portion 16 is coupled to the other end of the cooling plate 112 and is configured to guide a flow of the refrigerant introduced into the base flow path 120 in a discharge direction through the flow path connection portion 114.

The base flow path 120 may include an inflow flow path 121 through which the refrigerant flows inward (or is introduced) through the flow path connection portion 114 and flows in a first direction (e.g., the Y-axis direction) inside the cooling plate 112. The base flow path 120 also includes a discharge flow path 123 in which a flow direction of the refrigerant introduced through the inflow flow path 121 is changed at a position of the refrigerant guiding portion 16 to move in a second direction that is a reverse direction (i.e., the opposite direction) to the first direction.

The inflow flow path 121 may include a first inflow flow path 121a extending along the first direction inside one side of the cooling plate 112 to introduce the refrigerant and connected to the discharge flow path 123, and a second inflow flow path 121b extending along the first direction inside the other side of the cooling plate 112 to introduce the refrigerant and connected to the discharge flow path 123.

The first inflow flow path 121a may extend along one edge of the cooling plate 112, may be arranged lengthwise along the first direction inside the cooling plate 112, and may be configured such that the refrigerant introduced through the flow path connection portion 114 flows along the first direction (i.e., the Y-axis direction).

The first inflow flow path 121a may be connected to the discharge flow path 123 inside the cooling plate 112 to enable circulation of the refrigerant C.

The second inflow flow path 121b may extend along the other edge of the cooling plate 112, may be arranged lengthwise along the first direction inside the cooling plate 112, and may be configured such that the refrigerant introduced through the flow path connection portion 114 flows along the first direction.

The second inflow flow path 121b may be connected to the discharge flow path 123 inside the cooling plate 112 to enable circulation of the refrigerant C.

The discharge flow path 123 may be inside the cooling plate 112, and may be connected to each of the first inflow flow path 121a and the second inflow flow path 121b at a position of the refrigerant guiding portion 16 to enable circulation of the refrigerant.

In one or more embodiments, the discharge flow path 123 may include a first discharge flow path 123a and a second discharge flow path 123b inside the cooling plate 112 and between the first inflow flow path 121a and the second inflow flow path 121b.

The first discharge flow path 123a may extend along the first direction between the first inflow flow path 121a and the second inflow flow path 121b inside the cooling plate 112, and the first discharge flow path 123a may be connected to the first inflow flow path 121a to circulate and discharge the refrigerant.

The second discharge flow path 123b may extend along the first direction between the first inflow flow path 121a and the second inflow flow path 121b inside the cooling plate 112, and the second discharge flow path 123b may be connected to the second inflow flow path 121b to circulate and discharge the refrigerant.

In one or more embodiments, the refrigerant C may be introduced through the first inflow flow path 121a and the second inflow flow path 121b such that a flow direction of the refrigerant is changed (e.g., reversed) at a position of the refrigerant guiding portion 16 to circulate and discharge the refrigerant through the first discharge flow path 123a and the second discharge flow path 123b.

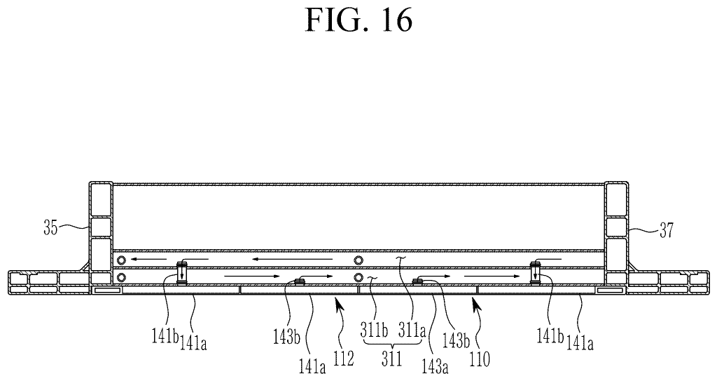

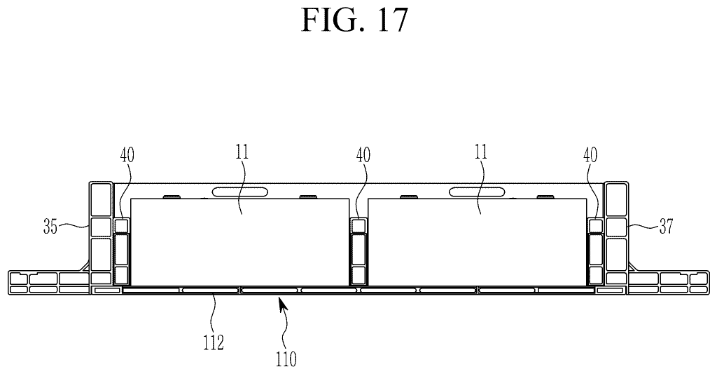

FIG. 16 is a cross-sectional view cut along a line C-C of FIG. 13 and schematically shows a state in which the composite frame and the base plate are connected by the flow path connection portion, and FIG. 17 is a cross-sectional view cut along a line D-D of FIG. 13.

Referring to FIG. 16 and FIG. 17, the flow path connection portion 114 may include the first connection portion 141 coupled to one end of the cooling plate 112 to connect the first inflow flow path 121a and the second inflow flow path 121b to the first side surface flow path 311 of the composite frame 31 of the frame portion 30. The flow path connection portion 114 may also include the second connection portion 143 coupled to one end of the cooling plate 112 to connect the first discharge flow path 123a and the second discharge flow path 123b to the side surface flow path of the frame portion 30.

The first connection portion 141 may be coupled to the first coupling groove 12a at the first inflow flow path 121a and the second inflow flow path 121b inside the cooling plate 112 such that the first connection portion 141 is connected to the upper flow path 311a of the composite frame 31.

The first connection portion 141 may include the first bending plate 141a in which one side covers the first coupling groove 12a and the other side is bent to extend in a thickness direction (the Z-axis direction) of the cooling plate 112, and the first pipe line 141b that protrudes upward from the first bending plate 141a and is extends into the inside of the composite frame 31 to connect the first and second inflow flow paths 121a and 121b and the upper flow path 311a.

One side of the first bending plates 141a may cover the first coupling groove 12a at each of the first inflow flow path 121a and the second inflow flow path 121b, and the other side of the first bending plates 141a may be bent downward to extend in a thickness direction (the Z-axis direction) of the cooling plate 112.

The first pipe line 141b may protrude upward from an upper side of the first bending plate 141a and extend into the frame portion 30 such that the first pipe line 141b connects the first and second inflow flow paths 121a and 121b to the first side surface flow path 311 of the composite frame 31.

The second connection portion 143 may be coupled to one end of the cooling plate 112 to connect the first discharge flow path 123a and the second discharge flow path 123b to the lower flow path 311b of the composite frame 31.

The second connection portion 143 may include the second bending plate 143a in which one side covers the first coupling groove 12a and the other side is bent downward to extend in a thickness direction (the Z-axis direction) of the cooling plate 112, and the second pipe line 143b that protrudes upward from the second bending plate 143a and extends into the inside of the composite frame 31 to connect the first discharge flow path 123a and the second discharge flow path 123b to the lower flow path 311b of the composite frame 31.

One side of the second bending plate 143a may cover the first coupling groove 12a formed at each of the first discharge flow path 123a and the second discharge flow path 123b, and the other side of the second bending plate 143a may be bent downward to extend in a thickness direction (the Z-axis direction) of the cooling plate 112.

The second pipe line 143b may protrude upward from an upper side of the second bending plate 143a and extend into the frame portion 30. The second pipe line 143b may connect the first and second discharge flow paths 123a and 123b to the lower flow path 311b of the first side surface flow path 311.

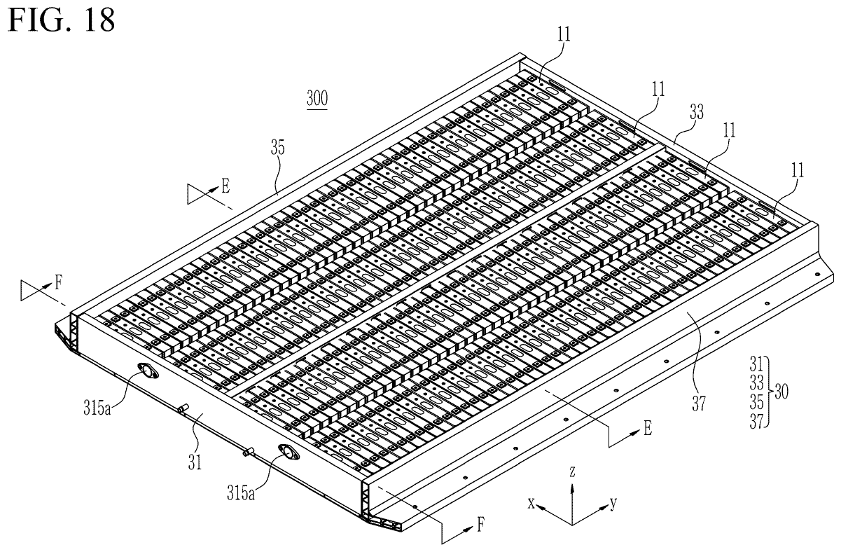

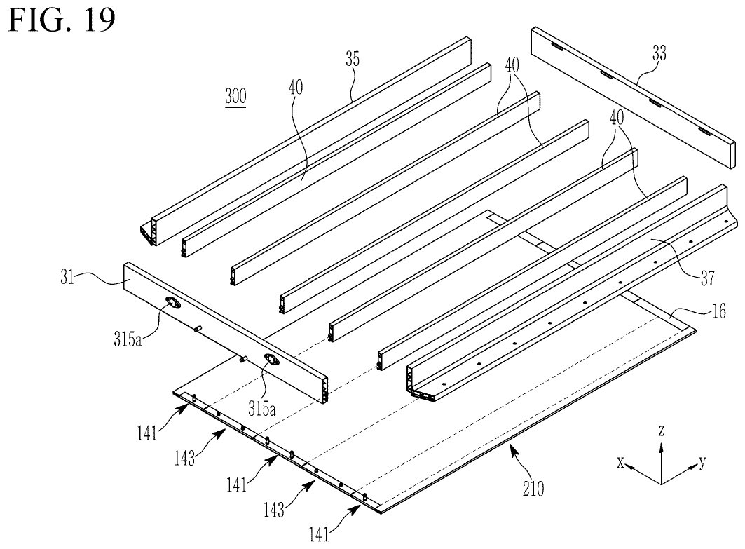

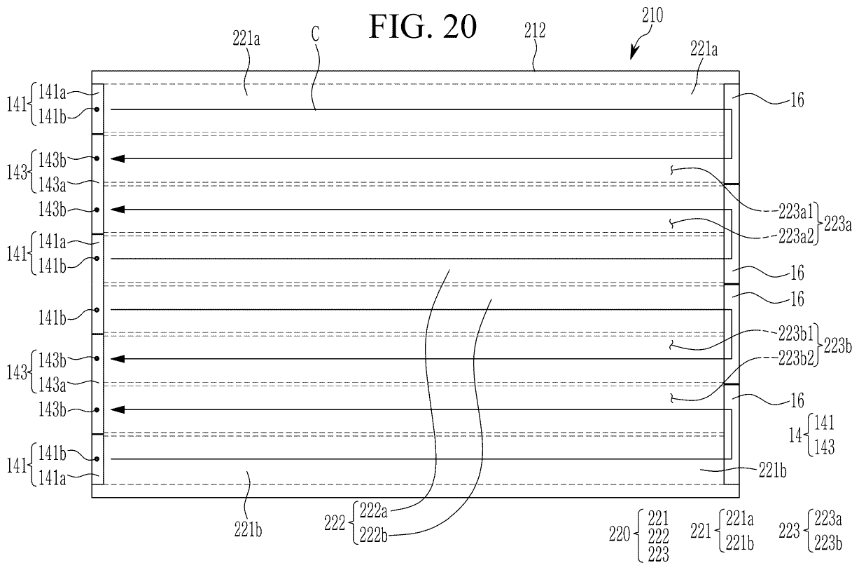

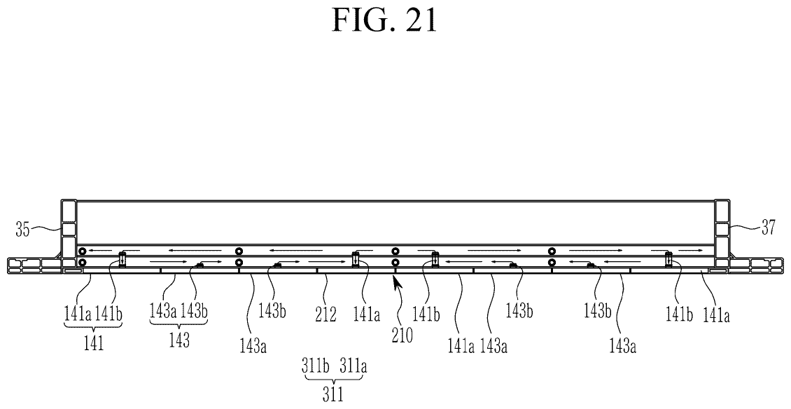

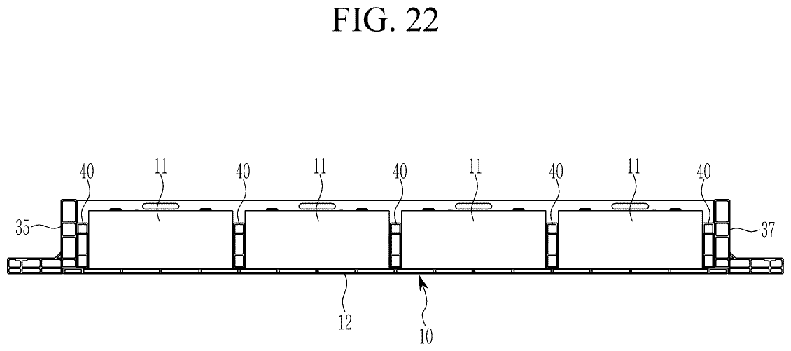

FIG. 18 is a perspective view schematically showing a battery pack according to a third embodiment of the present disclosure, FIG. 19 is an exploded perspective view schematically showing the battery pack of FIG. 18, FIG. 20 is a plan view schematically showing a base plate of FIG. 18, FIG. 21 is a cross-sectional view that is cut along a line F-F of FIG. 18 and schematically shows a state in which a composite frame and the base plate are connected by a flow path connection portion, and FIG. 22 is a cross-sectional view cut along a line E-E of FIG. 18. The same reference numeral as that in FIGS. 1 to 17 denotes the same or similar member having the same or similar function. Hereinafter, a detailed description of the same reference numerals is omitted.

As shown in FIGS. 18 to 22, the base plate 210 of the battery pack 300 according to the third embodiment of the present disclosure may include a cooling plate 212 in which the plurality of battery cells are in contact with a first surface of the base plate 212. A base flow path 220 is formed in the base plate 212. The flow path connection portion 14 is coupled to one end of the cooling plate 212 and connects the first side surface flow path 311 of the frame portion 30 and the base flow path 220. The refrigerant guiding portion 16 is coupled to the other end of the cooling plate 212 and is configured to guide a flow of the refrigerant introduced into the base flow path 220 in a discharge direction through the flow path connection portion 14.

The base flow path 220 may include an inflow flow path 221, a common inflow flow path 222, and a discharge flow path 223.

The inflow flow path 221 may be configured such that a first inflow flow path 221a, a second inflow flow path 221b, and the common inflow flow path 222 extend along a first direction (i.e., a length direction in the Y-axis direction) inside the cooling plate 212 and are spaced apart from each other in the X-axis direction.

The first inflow flow path 221a may extend along the first direction inside one edge portion of the cooling plate 212 so that the refrigerant may be introduced and the first inflow flow path 221a may be connected to the discharge flow path 223.

The second inflow flow path 221b may extend along the first direction inside an edge portion of the other side of the cooling plate 212 so that the refrigerant may be introduced and the second inflow flow path 221b may be connected to the discharge flow path 223.

The common inflow flow path 222 may include two flow paths that are formed along the first direction (the Y-axis direction) inside the cooling plate 212 between the first inflow flow path 221a and the second inflow flow path 221b and move the refrigerant. The common inflow flow path 222 may be connected to the discharge flow path 223.

The common inflow flow path 222 may include a first common inflow flow path 222a extending along the first direction inside the cooling plate 212 between the first inflow flow path 221a and the second inflow flow path 221b and is connected to a first common discharge flow path 223a to be described later. The common inflow flow path 222 may also include a second common inflow flow path 222b extending along the first direction inside the cooling plate 212 parallel or substantially parallel to the first common inflow flow path 222a and is connected to a second common discharge flow path 223b to be described later.

In one or more embodiments, a portion of the refrigerant introduced through the common inflow flow path 222 may flow through the first common inflow flow path 222a to circulate to the first common discharge flow path 223a.

A portion of the remaining refrigerant introduced through the common inflow flow path 222 may flow through the second common inflow flow path 222b to circulate through the second common discharge flow path 223b.

The discharge flow path 223 may be connected to the inflow flow path between the first inflow flow path 221a, the second inflow flow path 221b, and the common inflow flow path 222 to circulate the refrigerant.

The discharge flow path 223 may include the first common discharge flow path 223a inside the cooling plate 212 between the first inflow flow path 221a and the common inflow flow path 222, and the second common discharge flow path 223b inside the cooling plate 212 between the common inflow flow path 222 and the second inflow flow path 221b.

The first common discharge flow path 223a may be inside the cooling plate 212 extending in the first direction and may be connected to each of the first inflow flow path 221a and the common inflow flow path 222 such that the refrigerant moving through each of the first inflow flow path 221a and the common inflow flow path 222 is circulated and discharged.

In one or more embodiments, the first common discharge flow path 223a may include a first output flow path 223a1 inside the cooling plate 212 between the first inflow flow path 221a and the common inflow flow path 222 and connected to the first inflow flow path 221a to discharge the refrigerant, and a second output flow path 223a2 inside the cooling plate 212 on a side surface of the first output flow path 223a1 and connected to the first common inflow flow path 222a to discharge the refrigerant.

In one or more embodiments, the refrigerant introduced through the first inflow flow path 221a may be discharged through the first output flow path 223a1. The refrigerant introduced through the first common inflow flow path 222a may be discharged through the second output flow path 223a2.

The second common discharge flow path 223b may extend inside the cooling plate 212 between the common inflow flow path 222 and the second inflow flow path 221b along the first direction (the Y-axis direction) and may be connected to each of the common inflow flow path 222 and the second inflow flow path 221b such that the refrigerant flowing through each of the common inflow flow path 222 and the second inflow flow path 221b is circulated and discharged.

The second common discharge flow path 223b may include a third output flow path 223b1 inside the cooling plate 212 between the second inflow flow path 221b and the common inflow flow path 222 and connected to the second common inflow flow path 222b to discharge the refrigerant, and a fourth output flow path 223b2 inside the cooling plate 212 on a side surface of the third output flow path 223b1 and connected to the second inflow flow path 221b to discharge the refrigerant.

In one or more embodiments, the refrigerant introduced through the second common inflow flow path 222b may be discharged through the third output flow path 223b1. The refrigerant introduced through the second inflow flow path 221b may be discharged through the fourth output flow path 223b2.

In one or more embodiments, the flow path connection portion 14 may include the first connection portion 141 coupled to one end of the cooling plate 212 to connect the first inflow flow path 221a, the second inflow flow path 221b, and the common inflow flow path 222 to the side surface flow path of the frame portion 30, and the second connection portion 143 coupled to one end of the cooling plate 212 to connect the first common discharge flow path 223a and the second common discharge flow path 223b to the side surface flow path of the frame portion 30.

The first coupling groove 12a for coupling of the first connection portion 141 may be at one side of each of the first and second inflow flow paths 221a and 221b, the common inflow flow path 222, and the first and second common discharge flow paths 223a and 223b.

The first connection portion 141 may include the first bending plate 141a covering the first coupling groove 12a at the first and second inflow flow paths 221a and 221b and the common inflow flow path 222 and the other side is bent downward in a thickness direction (Z-axis direction) of the cooling plate 112. The first pipe line 141b protrudes upward from the first bending plate 141a and extends into the inside of the composite frame 31 and connects the first and second inflow flow paths 221a and 221b and the common inflow flow path 222 to the first side surface flow path 311 of the composite frame 31.

The first bending plates 141a may be coupled to each of the first and second inflow flow paths 221a and 221b and the common inflow flow path 222, and the first pipe line 141b may be coupled to an upper portion of the first bending plate 141a. The first pipe line 141b is configured to enable a circulating supply of the refrigerant by connecting the first and second inflow flow paths 221a and 221b and the common inflow flow path 222 to the first side surface flow path 311 of the composite frame 31.

The second connection portion 143 may include the second bending plate 143a having one side covering the first coupling groove 12a and the other side bent downward to extend in a thickness direction (the Z-axis direction) of the cooling plate. The second pipe line 143b protrudes upward from the second bending plate 143a and extends into the inside of the composite frame 31 to connect the first and second common discharge flow paths 223a and 223b to the side surface flow path.

The second bending plates 143b may be coupled to the first coupling groove 12a at each of the first and second inflow flow paths 221a and 221b and the common inflow flow path 222, and the second pipe line 143b may extend upward from an upper portion of the second bending plate 143b.

The second coupling groove 12b for coupling the refrigerant guiding portion 16 may be at the other side of each of each of the first and second inflow flow paths 221a and 221b, the common inflow flow path 222, and the first and second common discharge flow paths 223a and 223b.

As described above, the battery pack 300 of the third embodiment of the present disclosure may effectively cool three surfaces of a lower portion and a side surface of the battery cell 11 in a configuration in which the plurality of battery cells 11 including the battery cell are accommodated inside the frame portion. Cooling the battery cells 11 is configured to extend usage lifespan of the battery pack and improve durability of the battery pack.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

### DESCRIPTION OF SYMBOLS

10, 110: base plate 1: battery cell
12, 112: cooling plate 12a: first coupling groove
12b: second coupling groove 14, 114: flow path connection portion
141: first connection portion 141a: first bending plate
141b: first pipe line 141c: first sealing member
143: second connection portion 143a: second bending plate
143b: second pipe line 143c: second sealing member
16: refrigerant guiding portion 20, 120, 220: base flow path
21, 121, 221: inflow flow path 121a: first inflow flow path
121b: second inflow flow path 222: common inflow flow path
222a: first common inflow flow path
222b: second common inflow flow path
23, 123, 223: discharge flow path 223a: first common discharge flow path
223a1: first output flow path 223a2: second output flow path
223b: second common discharge flow path 223b1: third output flow path
223b2: fourth output flow path 123a: first discharge flow path
123b: second discharge flow path 30: frame portion
31: composite frame 33: end frame
35: first side frame 37: second side frame
311: first side surface flow path 311a: upper flow path
311b: lower flow path 312: gas inflow portion
314: gas venting portion 315: venting unit
315a: venting body 315b: venting protruding portion
316: guiding portion 40: side surface cooling frame
41: second side surface flow path 41a: side surface upper flow path
41b: side surface lower flow path 43: first plug
45: second plug 47: side surface refrigerant guiding portion

What is claimed is:

1. A battery pack comprising:
a plurality of battery cells;
a base plate comprising a first surface and a base flow path, wherein the plurality of battery cells is in contact with the first surface and the base flow path is configured to circulate a refrigerant to cool the plurality of battery cells; and
a frame portion comprising a plurality of frames coupled to each other at an upper side of the first surface of the base plate, the frame portion forming an accommodation space for accommodating the plurality of battery cells and a side surface flow path connected to the base flow path through which the refrigerant is configured to flow.

2. The battery pack as claimed in claim 1, wherein the base plate comprises:
a cooling plate comprising the first surface and the base flow path;
a flow path connection portion coupled to one end of the cooling plate and connecting the side surface flow path of the frame portion and the base flow path; and
a refrigerant guiding portion coupled to another end of the cooling plate, the refrigerant guiding portion being configured to guide a flow of the refrigerant introduced into the base flow path in a discharge direction through the flow path connection portion.

3. The battery pack as claimed in claim 2, wherein:
the base flow path comprises an inflow flow path through which the refrigerant introduced through the flow path connection portion moves in a first direction inside the cooling plate and a discharge flow path in which a flow direction of the refrigerant introduced through the inflow flow path is reversed at a position of the refrigerant guiding portion to move in a second direction opposite to the first direction,
the inflow flow path extends along the first direction inside one side of the cooling plate to introduce the refrigerant and is connected to the discharge flow path at the position of the refrigerant guiding portion, and
the discharge flow path is connected to the inflow flow path inside the cooling plate.

4. The battery pack as claimed in claim 3, further comprising a first coupling groove at the one end of the cooling plate coupled to the flow path connection portion, the first coupling groove opening a portion of each of the inflow flow path and the discharge flow path.

5. The battery pack as claimed in claim 4, wherein the flow path connection portion comprises:
a first connection portion coupled to the one end of the cooling plate to connect the inflow flow path to the side surface flow path of the frame portion; and
a second connection portion coupled to the one end of the cooling plate to connect the discharge flow path to the side surface flow path of the frame portion.

6. The battery pack as claimed in claim 5, wherein:
the first connection portion comprises a first bending plate including one side covering the first coupling groove and another side extending in a thickness direction of the cooling plate, and a first pipe line protruding from an upper side of the first bending plate and extending into the frame portion and connecting the inflow flow path and the side surface flow path, and
the second connection portion comprises a second bending plate including one side covering the first coupling groove and another side extending in the thickness direction of the cooling plate, and a second pipe line protruding from an upper side of the second bending plate and extending into the frame portion and connecting the inflow flow path and the side surface flow path.

7. The battery pack as claimed in claim 4, further comprising a second coupling groove at another end of the cooling plate, the second coupling groove being coupled to the refrigerant guiding portion and opening a portion of each of the inflow flow path and the discharge flow path.

8. The battery pack as claimed in claim 7, wherein the refrigerant guiding portion comprises a second bending plate including one side covering the second coupling groove and another side extending in a thickness direction of the cooling plate.

9. The battery pack as claimed in claim 6, wherein the frame portion comprises:
a composite frame coupled to one edge of the base plate, wherein a first side surface flow path is inside the composite frame and the first side surface flow path is connected to the first connection portion and the second connection portion to supply the refrigerant;
an end frame coupled to the another edge of the base plate;
a first side frame having each end connected to one end of each of the composite frame and the end frame; and
a second side frame having each end connected to another end of each of the composite frame and the end frame.

10. The battery pack as claimed in claim 9, further comprising a gas discharge portion in the composite frame configured to discharge a gas generated from one of the plurality of battery cells, wherein the gas discharge portion comprises a gas inflow portion on a first side surface of the composite frame and through which the gas generated from the one of the plurality of battery cells is introduced and a gas venting portion at the composite frame through which the gas introduced into the gas inflow portion is discharged to the outside.

11. The battery pack as claimed in claim 10, wherein an inside of the composite frame is divided into a first region and a second region, wherein the first side surface flow path is at the first region, and wherein the gas venting portion is at the second region.

12. The battery pack as claimed in claim 11, wherein the gas venting portion comprises:
a venting unit protruding from a second side surface facing the first side surface of the composite frame, the venting unit being configured to discharge the gas; and
a guiding portion protruding from an inner wall surface of the second region inside the composite frame, the guiding portion being configured to guide the gas toward the venting unit.

13. The battery pack as claimed in claim 9, wherein the frame portion further comprises a side surface cooling frame in contact with side surfaces of the plurality of battery cells.

14. The battery pack as claimed in claim 13, wherein one side of the side surface cooling frame is connected to the first side surface flow path of the composite frame, wherein another side of the side surface cooling frame extends in a direction toward the end frame, and wherein a second side surface flow path through which the refrigerant flows is inside the side surface cooling frame.

15. The battery pack as claimed in claim 14, wherein the first side surface flow path comprises an upper flow path connected to the first pipe line and a lower flow path connected to the second pipe line, and wherein the second side surface flow path comprises a side surface upper flow path extending in a length direction inside the side surface cooling frame and connected to the upper flow path of the composite frame and a side surface lower flow path extending in the length direction inside the side surface cooling frame and at a lower portion of the side surface upper flow path to be connected to the lower flow path of the composite frame.

16. The battery pack as claimed in claim 15, further comprising a side surface refrigerant guiding portion at another side of the side surface cooling frame, wherein the side surface refrigerant guiding portion is configured to change a flow direction of the refrigerant flowing through the side surface upper flow path to a direction of the side surface lower flow path.

17. The battery pack as claimed in claim 3, wherein the inflow flow path comprises a first inflow flow path extending along the first direction at one side of the cooling plate to introduce the refrigerant and connected to the discharge flow path and a second inflow flow path extending along the first direction at another side of the cooling plate to introduce the refrigerant and connected to the discharge flow path, and wherein the discharge flow path comprises a first discharge flow path extending along the first direction between the first inflow flow path and the second inflow flow path inside the cooling plate and connected to the first inflow flow path to discharge the refrigerant and a second discharge flow path extending along the first direction between the first inflow flow path and the second inflow flow path inside the cooling plate and connected to the second inflow flow path to discharge the refrigerant.

18. The battery pack as claimed in claim 17, wherein the flow path connection portion comprises:
a first connection portion coupled to the one end of the cooling plate to connect the first inflow flow path and the second inflow flow path to the side surface flow path of the frame portion; and
a second connection portion coupled to the one end of the cooling plate to connect the first discharge flow path and the second discharge flow path to the side surface flow path of the frame portion.

19. The battery pack as claimed in claim 3, wherein the inflow flow path comprises a first inflow flow path extending along the first direction inside one edge portion of the cooling plate so that the refrigerant is introduced and connected to the discharge flow path, a second inflow flow path extending along the first direction inside an edge portion of another side of the cooling plate so that the refrigerant is introduced and connected to the discharge flow path, and a common inflow flow path comprising two flow paths extending along the first direction inside the cooling plate between the first inflow flow path and the second inflow flow path and connected to the discharge flow path, and
wherein the discharge flow path comprises a first common discharge flow path extending along the first direction inside the cooling plate between the first inflow flow path and the common inflow flow path and connected to each of the first inflow flow path and the common inflow flow path to discharge the refrigerant and a second common discharge flow path extending along the first direction inside the cooling plate between the second inflow flow path and the common inflow flow path and connected to each of the second inflow flow path and the common inflow flow path to discharge the refrigerant.

20. The battery pack as claimed in claim 19, wherein the flow path connection portion comprises:
a first connection portion coupled to the one end of the cooling plate to connect the first inflow flow path, the second inflow flow path, and the common inflow flow path to the side surface flow path of the frame portion; and
a second connection portion coupled to the one end of the cooling plate to connect the first common discharge flow path and the second common discharge flow path to the side surface flow path of the frame portion.
